(19) United States
(12) Patent Application Publication
(10) Pub. No.: US 2007/0132395 A1
(43) Pub. Date: Jun. 14, 2007

(54) Display device

(76) Inventors: Hyoung-Bin Park, Suwon-si (KR); Seung-Hyun Son, Suwon-si (KR); Sang-Hun Jang, Suwon-si (KR); Gi-Young Kim, Suwon-si (KR); Sung-Soo Kim, Suwon-si (KR); Hidekazu Hatanaka, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/636,306

(22) Filed: Dec. 8, 2006

(30) Foreign Application Priority Data
Dec. 12, 2005 (KR) 10-2005-0121942

(51) Int. Cl. H01J 17/49

(52) U.S. Cl. 313/587

(57) ABSTRACT

Provided is a display device. The display device comprises a first substrate and a second substrate opposing each other at regular intervals, a plurality of barrier ribs disposed between the first substrate and the second substrate and partitioning a space between the first substrate and the second substrate to form a plurality of light-emitting cells, an excitation gas filled in the light-emitting cells, a light-emitting layer formed on inner walls of the light-emitting cells, and a first electron emission member disposed in each of the light-emitting cells inside the first substrate, emitting a first electron beam for exciting the excitation gas into the light-emitting cells and including a first electrode formed on an inner surface of the first substrate and a first electron emission source formed of boron nitride bamboo shoot (BNBS) on the first electrode.

### CROSS-REFERENCE TO RELATED APPLICATIONS

This application claims the benefit of Korean Patent Application No. 10-2005-0121942, filed on Dec. 12, 2005, in the Korean Intellectual Property Office, the disclosure of which is incorporated herein in its entirety by reference.

### BACKGROUND OF THE INVENTION

1. Field of the Invention

The present embodiments relate to a display device, and more particularly, to a display device in which a driving voltage can be reduced and life span can be increased.

2. Description of the Related Art

Plasma display panels (PDP) which are a type of display devices are apparatuses for forming an image using an electrical discharge. In a PDP, a discharge gas is sealed between two substrates on which a plurality of discharge electrodes is formed, a discharge voltage is applied, phosphors formed in a predetermined pattern are excited by ultraviolet rays generated by the discharge voltage and a desired image is generated.

PDP can be classified into two types according to a discharge manner. One type is a DC PDP in which all electrodes are exposed to a discharge space and the movement of electrons between corresponding electrodes is direct. The other type is an AC PDP in which at least one electrode is buried by a dielectric layer and the movement of electrons between corresponding electrodes is not direct and a discharge occurs through wall charges.

PDP can also be classified into two types according to an arrangement structure of electrodes. One type is a facing discharge PDP in which two sustain electrode pairs are disposed on an upper substrate and a lower substrate, respectively, and a discharge occurs in a direction perpendicular to the substrates. The other type is a surface discharge PDP in which two sustain electrode pairs are disposed on the same substrate and a discharge occurs in a direction parallel to the substrate.

In a facing discharge PDP, luminous efficiency is high but the phosphor layer is easily degraded by plasma. Thus, a surface discharge PDP is usually used. FIG. 1 illustrates a conventional surface discharge plasma display panel (PDP). FIGS. 2A and 2B are cross-sectional views of the PDP illustrated in FIG. 1 in horizontal and vertical directions, respectively.

Referring to FIGS. 1, 2A and 2B, the conventional PDP includes an upper substrate 20 and a lower substrate 10 that oppose each other at regular intervals. A space between the upper substrate 20 and the lower substrate 10 is a discharge space in which a plasma discharge occurs.

A plurality of address electrodes 11 are arranged on a top surface of the lower substrate 10 in a stripe shape. The address electrodes 11 are buried by a first dielectric layer 12. A plurality of barrier ribs 13 which partition the discharge space and form a plurality of discharge cells 14 are formed on a top surface of the first dielectric layer 12 at regular intervals. The barrier ribs 13 prevent electrical and optical crosstalk between the discharge cells 14. A phosphor layer 15 is formed on an inner surface of the discharge cells 14 to a predetermined thickness, and a discharge gas is filled in the discharge cells 14.

The upper substrate 20 is a transparent substrate which visible rays can transmit. The upper substrate 20 is usually formed of glass and is combined with the lower substrate 10 on which barrier ribs 13 are formed. Sustain electrodes 21a and 21b having a stripe shape, which intersect the address electrodes 11 are formed in the form of pair on a bottom surface of the upper substrate 20. The sustain electrodes 21a and 21b are usually formed of a transparent conductive material such as indium tin oxide (ITO) so that visible rays can transmit the sustain electrodes 21a and 21b. In order to reduce line resistance of the sustain electrodes 21a and 21b, bus electrodes 22a and 22b formed of metal are formed on a bottom surface of each of the sustain electrodes 21a and 21b to a smaller width than that of the sustain electrodes 21a and 21b. The sustain electrodes 21a and 21b and the bus electrodes 22a and 22b are buried by a transparent second dielectric layer 23. A protective layer 24 made of magnesium oxide (MgO) is formed on a bottom surface of the second dielectric layer 23.

In the PDP having the above structure, the protective layer 24 prevents damages of the second dielectric layer 23 caused by sputtering of plasma particles, emits secondary electrodes and reduces a discharge voltage. However, since the protective layer 24 made of MgO has a low secondary electron emission coefficient, there is a limitation in making a sufficient electron emission effect in the discharge space.

To address the problems, a cross section of a plasma display panel (PDP) disclosed in U.S. Pat. No. 6,346,775 is illustrated in FIG. 3.

Referring to FIG. 3, an upper substrate 40 and a lower substrate 30 are disposed to oppose each other and a discharge space is formed between the upper substrate 40 and the lower substrate 30. A plurality of barrier ribs 33 that partition the discharge space and form discharge cells 34 are disposed between the upper substrate 40 and the lower substrate 30. Address electrodes 31 are formed on a top surface of the lower substrate 30. The address electrodes 31 are buried by a first dielectric layer 32 formed on the top surface of the lower substrate 30. Sustain electrodes 41 are formed on a bottom surface of the upper substrate 40. The sustain electrodes 41 are buried by a second dielectric layer 43 formed on the bottom surface of the upper substrate 40. A secondary electron amplification structure in which a protective layer 44 and a carbon nanotube (CNT) 45 are sequentially stacked is formed on a bottom surface of the second dielectric layer 43. In the PDP of FIG. 3, due to the secondary electron amplification structure, efficiency and brightness are improved and a discharge voltage is reduced. However, the CNT 45 may be destroyed during a discharge and the life span of the PDP may be reduced.

In the above-described conventional PDPs, xenon (Xe) in an excited state is stabilized when a discharge gas is ionized and a plasma discharge occurs, and ultraviolet rays are generated. Thus, a sufficient high energy to ionize the discharge gas is needed so that an image can be formed. Thus, a driving voltage is increased and a luminous efficiency is lowered. Thus a display device in which a driving voltage can be reduced and life span can be increased is needed.

### SUMMARY OF THE INVENTION

The present embodiments provide a display device in which a driving voltage can be reduced and life span may be increased.

According to an aspect of the present embodiments, there is provided a display device including: a first substrate and a second substrate opposing each other at regular intervals; a plurality of barrier ribs disposed between the first substrate and the second substrate and partitioning a space between the first substrate and the second substrate to form a plurality of light-emitting cells; an excitation gas filled in the light-emitting cells; a light-emitting layer formed on inner walls of the light-emitting cells; and a first electron emission member disposed in each of the light-emitting cells inside the first substrate, emitting a first electron beam for exciting the excitation gas into the light-emitting cells and including a first electrode formed on an inner surface of the first substrate and a first electron emission source formed of boron nitride bamboo shoot (BNBS) on the first electrode.

The first electron beam may have an energy which is larger than an energy needed to excite the excitation gas and is smaller than an energy needed to ionize the excitation gas.

A second electrode may be further formed on an inner surface of the second substrate in each of the light-emitting cells. In addition, the display device may further include a third electrode disposed to be adjacent to a surface directed to light-emitting cells of the first electron emission source. In this case, if voltages applied to the first electrode, the second electrode and the third electrode, respectively, are V₁, V₂, and V₃, V₁<V₃<V₂ or V₁<V₂, V₁<V₃ and V2 and V3 are substantially equal.

The second and third electrodes may have a mesh structure. A dielectric layer may be further formed on the inner surface of the second substrate to cover the second electrode and a protective layer can be formed on the dielectric layer.

The excitation gas may comprise, for example, xenon (Xe) and the first electron beam may have an energy of from about 8.28 to about 12.13 eV.

The display device may further include a second electron emission member disposed in each of the light-emitting cells inside the second substrate, emitting a second electron beam for exciting the excitation gas into the light-emitting cells and including a second electrode formed on an inner surface of the second substrate and a second electron emission source formed of BNBS on the second electrode.

The display device may further include a third electrode disposed to be adjacent to a surface directed to light-emitting cells of the first electron emission source, and a fourth electrode disposed to be adjacent to a surface directed to light-emitting cells of the second electron emission source. In this case, if voltages applied to the first electrode, the second electrode, the third electrode and the fourth electrode, respectively, are V₁, V₂, V₃, and V₄, then V₁<V₃ and V₂<V₄ may be satisfied.

According to another aspect of the present embodiments, there is provided a display device including: a first substrate and a second substrate opposing each other at regular intervals and forming a plurality of light-emitting cells therebetween; an excitation gas filled in the light-emitting cells; a light-emitting layer formed on inner walls of the light-emitting cells; first and second electron emission members disposed between the first substrate and the second substrate in each of the light-emitting cells which emit first and second electron beams for exciting the excitation gas into the light-emitting cells, wherein the first electron emission member includes a first electrode disposed on one side of the light-emitting cells and a first electron emission source formed of boron nitride bamboo shoot (BNBS) inside the first electrode, and the second electron emission member includes a second electrode disposed on the other side of the light-emitting cells and a second electron emission source formed of BNBS inside the second electrode.

The display device may further include an address electrode formed on an inner surface of the first substrate in each of the light-emitting cells, and a dielectric layer may be formed on the inner surface of the first substrate to cover the address electrode.

According to another aspect of the present embodiments, there is provided a display device including: a first substrate and a second substrate opposing each other at regular intervals; a plurality of barrier ribs disposed between the first substrate and the second substrate and partitioning a space between the first substrate and the second substrate to form a plurality of light-emitting cells; an excitation gas filled in the light-emitting cells; a light-emitting layer formed on inner walls of the light-emitting cells; and first and second electron emission members disposed inside the second substrate in each of the light-emitting cells and emitting first and second electron beams for exciting the excitation gas into the light-emitting cells, wherein the first electron emission member includes a first electrode disposed on one portion of an inner surface of the second substrate and a first electron emission source formed of boron nitride bamboo shoot (BNBS) inside the first electrode, and the second electron emission member includes a second electrode disposed at the other portion of the inner surface of the second substrate and a second electron emission source formed of BNBS inside the second electrode.

### BRIEF DESCRIPTION OF THE DRAWINGS

The above and other features and advantages of the present embodiments will become more apparent by describing in detail exemplary embodiments thereof with reference to the attached drawings in which:

FIG. 1 is an exploded perspective view of a conventional plasma display panel (PDP);

FIGS. 2A and 2B are cross-sectional views of the PDP illustrated in FIG. 1;

FIG. 3 is a cross-sectional view of another conventional PDP;

FIG. 4 is a schematic cross-sectional view of a display device according to an embodiment;

FIG. 5 shows a microscopic photo showing an enlarged shape of BNBS;

FIG. 6 is a schematic view of a crystalline structure of BNBS;

FIG. 7 shows an energy level of xenon (Xe);

FIG. 8 is a partial cross-sectional view of a display device according to another embodiment;

FIGS. 9A through 9D illustrate voltage types that can be applied to respective electrodes in the display device illustrated in FIG. 4;

FIG. 10 is a schematic cross-sectional view of a modified example of a display device according to an embodiment;

FIG. 11 is a schematic cross-sectional view of a portion of a display device according to another embodiment;

FIG. 12 illustrate voltage types that can be applied to respective electrodes in the display device illustrated in FIG. 11;

FIG. 13 is a schematic cross-sectional view of a portion of a display device according to another embodiment;

FIG. 14 is a schematic cross-sectional view of a portion of a display device according to another embodiment;

FIG. 15 is a schematic cross-sectional view of a portion of a display device according to another embodiment; and

FIG. 16 illustrates voltage types that can be applied to respective electrodes in the display device illustrated in FIG. 15.

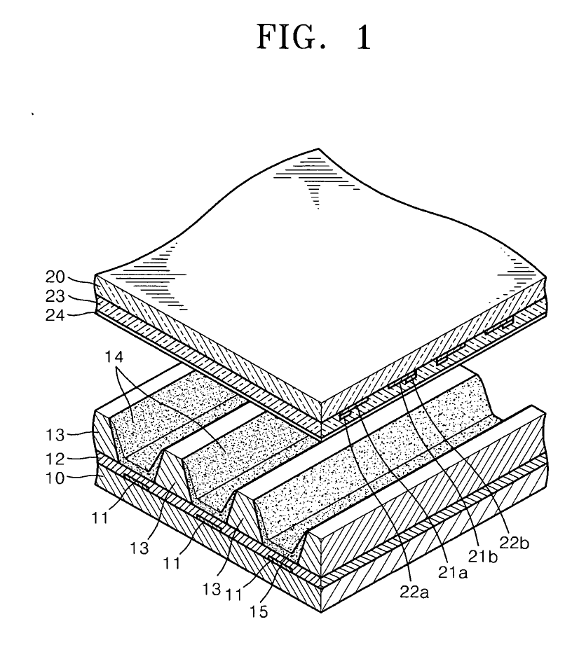

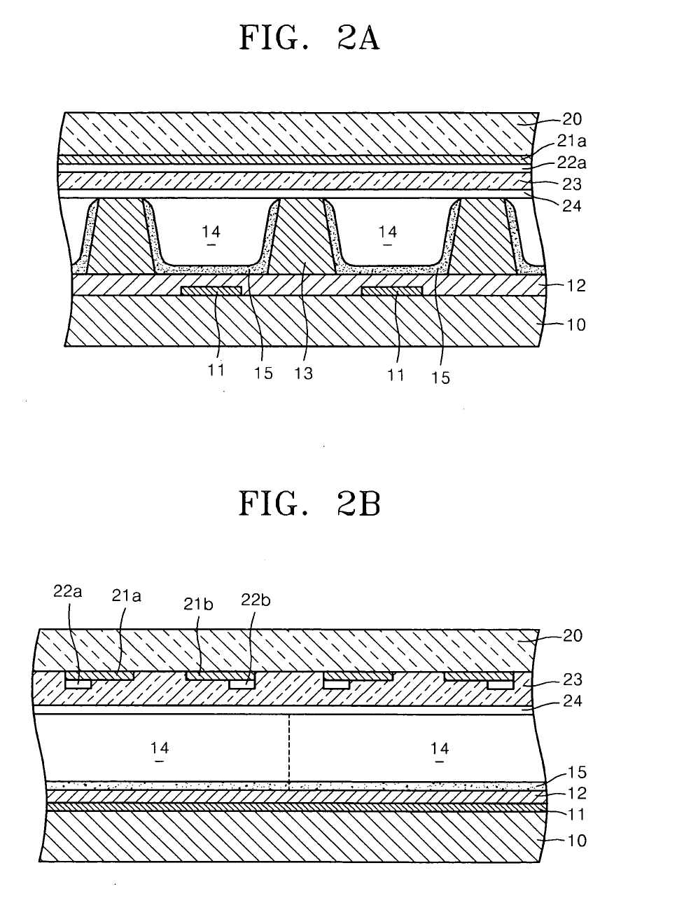

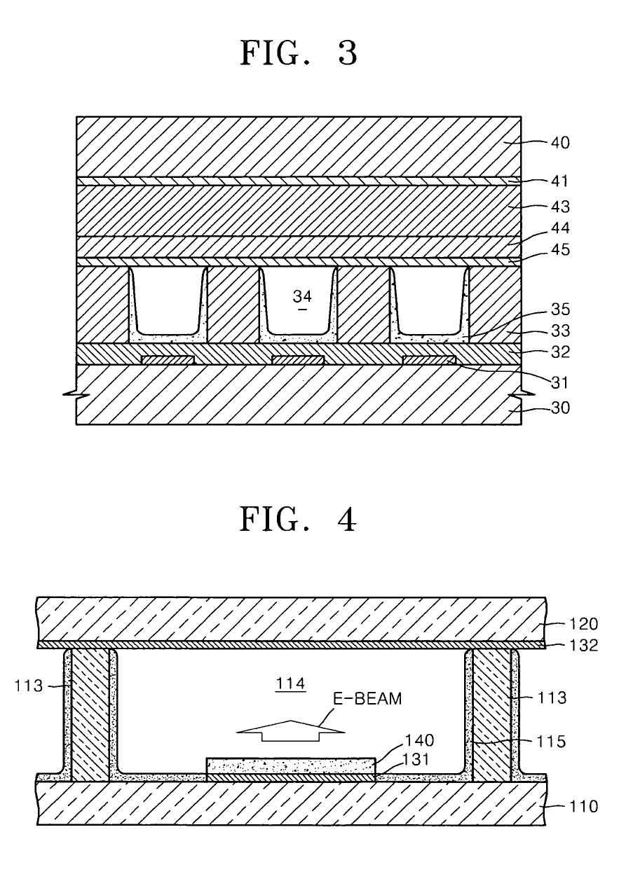

### DETAILED DESCRIPTION OF THE PREFERRED EMBODIMENT

The present embodiments will now be described in greater detail by explaining exemplary embodiments with reference to the attached drawings. Like reference numerals in the drawings denote like elements.

FIG. 4 is a cross-sectional view of a portion of a display device according to an embodiment.

Referring to FIG. 4, a first substrate 110 which is a lower substrate and a second substrate 120 which is an upper substrate are disposed to oppose each other at regular intervals. The first substrate 110 and the second substrate 120 may be, for example, transparent glass substrates. A plurality of barrier ribs 113 which partition a space between the first substrate 110 and the second substrate 120 form a plurality of light-emitting cells 114 between the first substrate 110 and the second substrate 120. The barrier ribs 113 prevent electrical and optical crosstalk between the light-emitting cells 114. Light-emitting layers 115 are applied to inner walls of the light-emitting cells 114 to a predetermined thickness. A phosphor, such as a light-emitting phosphor which is excited by UV rays and generates visible rays, is usually used to form the light-emitting layers 115. In addition, a cathode luminescence phosphor or a quantum dot can be used to form the light-emitting layers 115. An excitation gas including, for example, Xe is generally filled in the light-emitting cells 114. The excitation gas is a gas which is excited by an external energy such as an electron beam and generates UV rays. A portion of the excitation gas may act as a discharge gas.

An electron emission member is disposed on the top surface of the first substrate 110 in each of the light-emitting cells 114. The electron emission member includes a first electrode 131 formed on a top surface of the first substrate 110, and an electron emission source 140 formed on a top surface of the first electrode 131. A second electrode 132 is formed on a bottom surface of the second substrate 120 in each of the light-emitting cells 114 in a direction that intersects the electron emission member. The first electrode 131 and the second electrode 132 are a cathode electrode, an anode electrode, and a grid electrode, respectively. The second electrode 132 may be formed of a transparent conductive material such as, for example, indium tin oxide (ITO) so that visible rays can transmit the second electrode 132. A dielectric layer (not shown) may be formed on the bottom surface of the second substrate 120 to cover the second electrode 132. A protective layer (not shown) made of, for example, magnesium oxide (MgO) may be further formed on a surface of the dielectric layer.

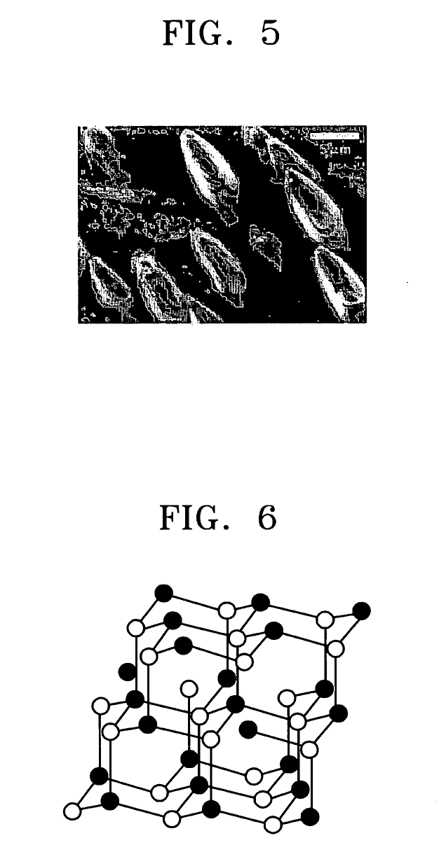

In some embodiments, the electron emission source 140 can be formed of boron nitride bamboo shoot (BNBS). The BNBS is a name of sp³ bonding 5H-BN which is a new material that has been developed by National Institute for Material Science (NIMS) in Tsukuba, Ibaraki, Japan. FIG. 5 shows a microscopic photo showing the shape of BNBS. Referring to FIG. 5, BNBS has an end formed to be sharp in a bamboo shape. Due to the shape, BNBS is referred to as boron nitride bamboo shoot. Since the BNBS has a transparent property in a wavelength region of about 380-780 nm which is in the visible region of the spectrum and has negative electron affinity, it has excellent electron emission characteristics. Specifically, since the BNBS facilitates several hundreds of current densities in the same electric field compared to a carbon nanotube (CNT), it has better electron emission characteristics compared to the CNT. In addition, a crystalline structure of BNBS is schematically shown in FIG. 6. Referring to FIG. 6, a boron nitride-based material such as BNBS has a crystalline structure of a cubic shape. Due to the crystalline structure of cubic shape, the boron nitride-based material such as BNBS is stable and solid (see Handbook of Refractory Carbides and Nitrides, High 0. Pierson, Noyes Publication, Table 13.6, p. 236, 1966).

If a predetermined voltage is applied to the first electrode 131, the electron emission source 140 formed of BNBS emits electrons from the first electrode 131 in an electron beam (E-beam) shape into the light-emitting cells 114. The emitted electrons are accelerated toward the second electrode 132 due to a voltage applied between the first electrode 131 and the second electrode 132. The E-beam emitted into the light-emitting cells 114 excites the excitation gas, and the excited excitation gas is stabilized and UV rays are generated. The UV rays excite the light-emitting layers 115 so that visible rays are generated. The visible rays are emitted toward the second substrate 120 so that an image is formed. BNBS which is a material used to form the electron emission source 140 has better electron emission characteristics than the CNT.

The E-beam emitted from the electron emission source 140 may have an energy which is larger than an energy needed to excite the excitation gas and is smaller than an energy needed to ionize the excitation gas. Thus, voltages are applied to the first electrode 131 and the second electrode 132, respectively, so that the E-beam can have an optimized electron energy for exciting the excitation gas.

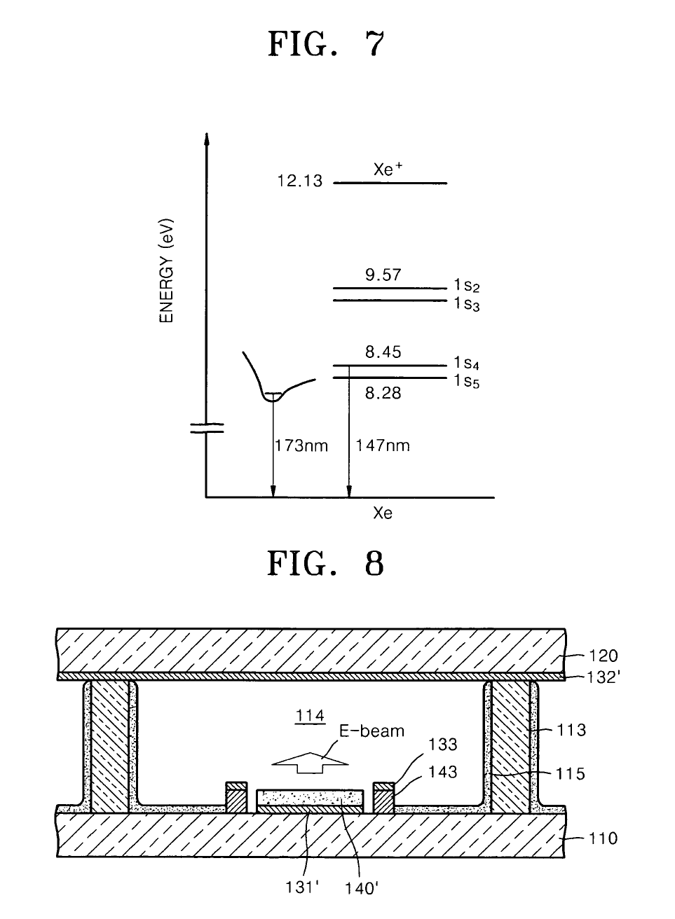

An energy level of Xe which is a source for generating UV rays is schematically shown in FIG. 7. Referring to FIG. 7, an energy of about 12.13 eV is needed to ionize Xe and an energy of more than about 8.28 eV is needed to excite Xe. Specifically, energies of about 8.28 eV, about 8.45 eV, and about 9.57 eV are needed to excite Xe in states 1S₅, 1S₄, and 1S₂, respectively. The excited Xenon Xe* is stabilized and UV rays of about 147 nm are generated. If the excited state Xenon Xe* and a ground state Xenon Xe collide each other, eximer Xenon Xe₂* is generated. If the eximer Xenon Xe₂* is stabilized, UV rays of about 173 nm are generated.

As a result, when an excitation gas including Xe is used, the E-beam emitted into the light-emitting cells 114 from the electron emission source 140 may have an energy of from about 8.28 to about 12.13 eV so as to excite Xe.

FIG. 8 is a partial cross-sectional view of a display device according to another embodiment. Referring to FIG. 8, a plurality of barrier ribs 113 which partition a space between a first substrate 110 and a second substrate 120 that face each other, and form a plurality of light-emitting cells 114 between the first substrate 110 and the second substrate 120. The barrier ribs 113 prevent electrical and optical crosstalk between the light-emitting cells 114. Light-emitting layers 115 are applied to inner walls of the light-emitting cells 114 to a predetermined thickness. An excitation gas including, for example, Xe is generally filled in the light-emitting cells 114. An electron emission member is disposed on the top surface of the first substrate 110 in each of the light-emitting cells 114. The electron emission member includes a first electrode 131′ formed on a top surface of the first substrate 110, an electron emission source 140′ formed on a top surface of the first electrode 131′, and a third electrode 133 formed to be adjacent to the electron emission source 140′. Even in the present embodiment, the electron emission source 140′ is formed of boron nitride bamboo shoot (BNBS). The third electrode 133 is formed to be adjacent to a surface directed to the light-emitting cells 114 of the electron emission source 140′ by a dielectric support layer 143 formed to a predetermined depth.

A second electrode 132′ is formed on a bottom surface of the second substrate 120 in each of the light-emitting cells 114 in a direction that intersects the electron emission member. The first electrode 131′, the second electrode 132′, and the third electrode 133 are a cathode electrode, an anode electrode, and a grid electrode, respectively. The second electrode 132′ may be formed of a transparent conductive material such as indium tin oxide (ITO) so that visible rays can transmit the second electrode 133. A dielectric layer (not shown) may be formed on the bottom surface of the second substrate 120 to cover the second electrode 132′. A protective layer (not shown) made of, for example, magnesium oxide (MgO) may be further formed on a surface of the dielectric layer.

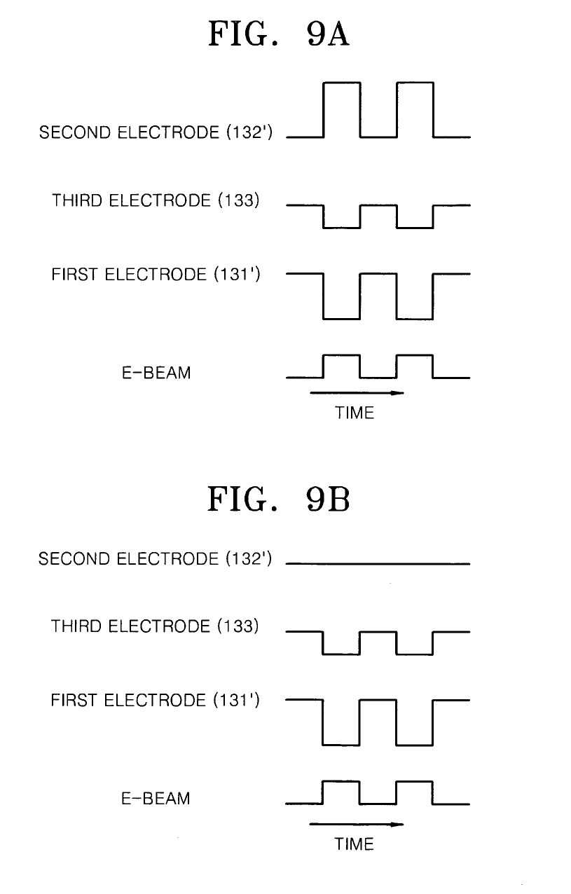

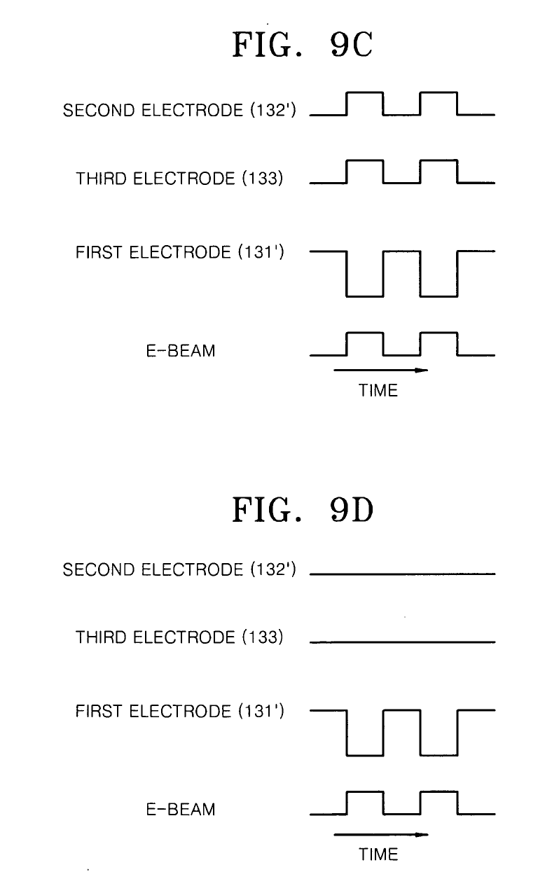

FIGS. 9A through 9D illustrate voltage types that can be applied to respective electrodes in the display device illustrated in FIG. 5.

Referring to FIG. 9A, pulse voltages are applied to the first electrode 131′, the second electrode 132′, and the third electrode 133, respectively. In this case, if voltages applied to the first electrode 131′, the second electrode 132′, and the third electrode 133, respectively, are V₁, V₂, and V₃, predetermined voltages are applied to the first, second, and third electrodes 131′, 132′, and 133 so that V₁<V₃<V₂ can be satisfied. If the above voltages are applied to the first, second, and third electrodes 131′, 132′, and 133, the E-beam is emitted into the light-emitting cells 114 from the electron emission source 140 due to the voltages applied to the first electrode 131′ and the third electrode 133. The emitted E-beam is accelerated toward the second electrode 132′ due to the voltages applied to the third electrode 133 and the second electrode 132′ and the excitation gas is excited in this procedure. The voltage applied to the second electrode 132′ is adjusted so that a portion of the excitation gas can also be adjusted in a discharge state. The second electrode 132′ can be grounded, as illustrated in FIG. 9B. Electrons that reach the second electrode 132′ can be emitted to the outside.

Referring to FIG. 9C, if voltages applied to the first electrode 131′, the second electrode 132′, and the third electrode 133, respectively, are V₁, V₂, and V₃, predetermined voltages are applied to the first, second, and third electrodes 131′, 132′, and 133 so that V₁<V₃, V₁<V₂ and V2 and V3 are substantially equal. If the above voltages are applied to the first, second, and third electrodes 131′, 132′, and 133, the E-beam is emitted into the light-emitting cells 114 from the electron emission source 140 due to the voltages applied to the first electrode 131′ and the third electrode 133. The excitation gas is excited by the emitted E-beam. The second electrode 132′ and the third electrode 133 can be grounded, as illustrated in FIG. 9D. In this case, electrons that reach the second electrode 132′ can be emitted to the outside.

In this way, in the display device illustrated in FIG. 4, the electron emission member including the electron emission source 140 emits the E-beam having an energy only to excite the excitation gas such that the display device can be driven at a lower voltage than in a conventional PDP. In addition, since the electron emission source 140 is formed of BNBS having a very excellent electron emission characteristic, a driving voltage can be further reduced. When a portion of the excitation gas is in the discharge state in the light-emitting cells 114, the BNBS has a very solid structure to withstand a shock caused by ions so that the life span of the display device can be increased.

FIG. 10 illustrates a modified example of a display device according to an embodiment. Only differences between FIGS. 4 and 10 will now be described. Referring to FIG. 10, a second electrode 132″ formed on a bottom surface of a second substrate 120 is formed in a mesh structure so that visible rays generated in the light-emitting cells 114 can transmit the second electrode 132″.

As described above, in FIG. 4, the first substrate 110 becomes a lower substrate and the second substrate 120 becomes an upper substrate. However, according to the current embodiment, the first substrate 110 on which the electron emission source 140 is formed may be an upper substrate and the second substrate 120 may be a lower substrate.

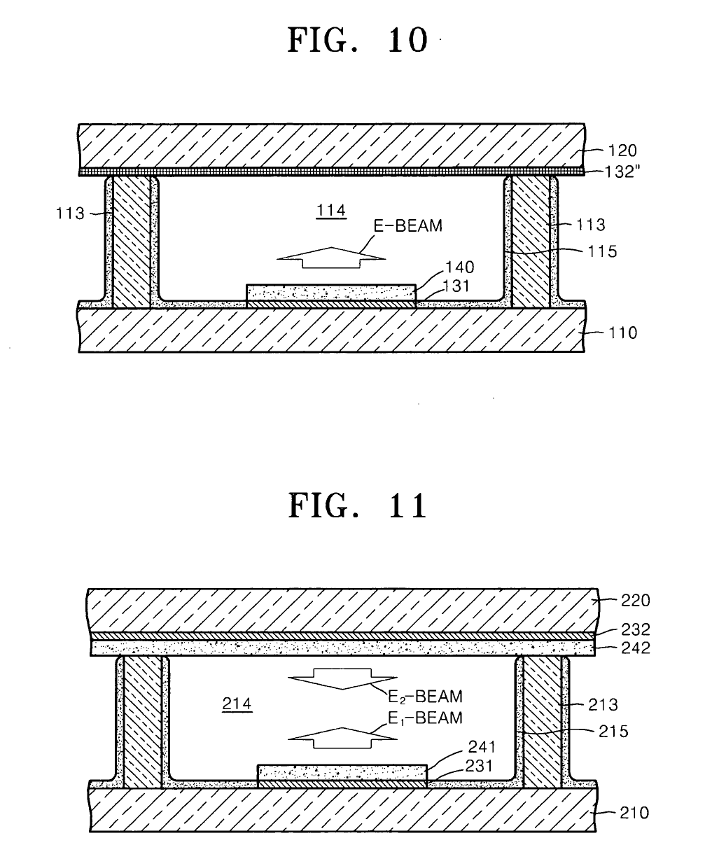

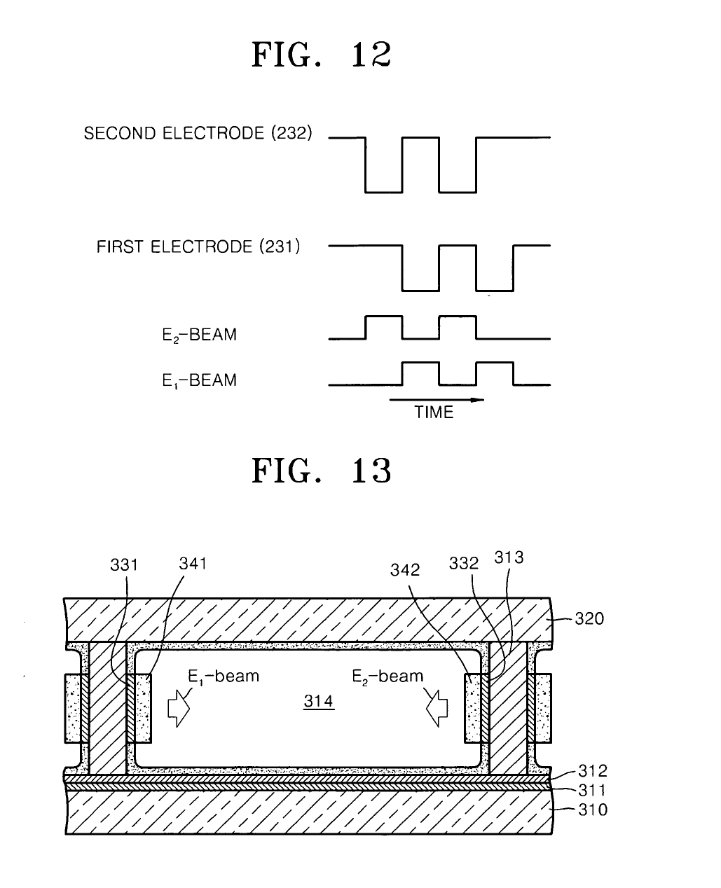

FIG. 11 is a schematic cross-sectional view of a portion of a display device according to another embodiment.

Referring to FIG. 11, a first substrate 210 and a second substrate 220 are disposed to oppose each other at regular intervals. A plurality of barrier ribs 213 which partition a space between the first substrate 210 and the second substrate 220 and form a plurality of light-emitting cells 214 are disposed between the first substrate 210 and the second substrate 220. Light-emitting layers 215 are applied to inner walls of the light-emitting cells 214 and an excitation gas including, for example, Xe is filled in the light-emitting cells 214.

A first electron emission member is disposed on a top surface of the first substrate 210 in each of the light-emitting cells 214. A second electron emission member is disposed on a bottom surface of the second substrate 220 in each of the light-emitting cells 214 in a direction that intersects the first electron emission member. The first electron emission member includes a first electrode 231 formed on the top surface of the first substrate 210 and a first electron emission source 241 formed on a top surface of the first electrode 231. The second electron emission member includes a second electrode 232 formed on the bottom surface of the second substrate 220 and a second electron emission source 242 formed on a bottom surface of the second electrode 232. The first and second electron emission sources 241 and 242 are formed of BNBS which is a material having excellent electron emission characteristics, as described above.

If a predetermined voltage is applied to the first electrode 231, the first electron emission source 241 emits electrons flown from the first electrode 231 as a first electron beam (E₁-beam) into the light-emitting cells 214. If a predetermined voltage is applied to the second electrode 232, the second electron emission source 242 emits electrons flown from the second electrode 232 as a second electron beam (E₂-beam) into the light-emitting cells 214. The first and second electron beams (E₁-beam, E₂-beam) can be alternately emitted into the light-emitting cells 214 according to the voltages applied to the respective electrodes. Each of the E₁-beam and the E₂-beam excites the excitation gas, and the excited excitation gas is stabilized and UV rays for exciting the light-emitting layers 215 are generated. Thus, the E₁-beam and the E₂-beam may have an energy which is larger than an energy needed to excite the excitation gas and is smaller than an energy needed to ionize the excitation gas, as described above. Specifically, when the excitation gas including Xe is used, the E₁-beam and the E₂-beam may have an energy of from about 8.28 to about 12.13 eV needed to excite Xe.

If a predetermined voltage is applied to the first electrode 231, the first electron emission source 241 emits electrons flown from the first electrode 231 as a first electron beam (E₁-beam) into the light-emitting cells 214. If a predetermined voltage is applied to the second electrode 232, the second electron emission source 242 emits electrons flown from the second electrode 232 as a second electron beam (E₂-beam) into the light-emitting cells 214. The first and second electron beams (E₁-beam, E₂-beam) can be alternately emitted into the light-emitting cells 214 according to the voltages applied to the respective electrodes. Each of the E₁-beam and the E₂-beam excites the excitation gas, and the excited excitation gas is stabilized and UV rays for exciting the light-emitting layers 215 are generated. Thus, the E₁-beam and the E₂-beam may have an energy which is larger than an energy needed to excite the excitation gas and is smaller than an energy needed to ionize the excitation gas, as described above. Specifically, when the excitation gas including Xe is used, the E₁-beam and the E₂-beam may have an energy of from about 8.28 to about 12.13 eV needed to excite Xe.

The second electrode 232 may be formed of a transparent conductive material, such as ITO, so that visible rays can transmit the second electrode 232. A plurality of address electrodes (not shown) may be further formed on one of the first substrate 210 and the second substrate 220.

FIG. 12 illustrates voltage types that can be applied to respective electrodes in the display device illustrated in FIG. 11.

Referring to FIG. 12, pulse voltages are applied to the first electrode 231 and the second electrode 232, respectively. The E₁-beam is emitted into the light-emitting cells 214 from the first electron emission source 241 due to the voltage applied to the first electrode 231, and the E₂-beam is emitted into the light-emitting cells 214 from the second electron emission source 242 due to the voltage applied to the second electrode 232. The E₁-beam and the E₂-beam are alternately emitted into the light-emitting cells 214 and the excitation gas is excited.

FIG. 13 is a schematic cross-sectional view of a portion of a display device according to another embodiment.

Referring to FIG. 13, a first substrate 310 and a second substrate 320 are disposed to oppose each other at regular intervals and a plurality of barrier ribs 313 for partitioning a plurality of light-emitting cells 314 are formed between the first substrate 310 and the second substrate 320. A plurality of address electrodes 311 are formed on a top surface of the first substrate 310, and the address electrodes 311 are buried by a dielectric layer 312. Light-emitting layers 315 are applied to inner walls of the light-emitting cells 314 and an excitation gas including Xe is filled in the discharge cells 314.

First and second electron emission members are disposed between the first substrate 310 and the second substrate 320 in each of the light-emitting cells 314. The first electron emission member includes a first electrode 331 formed on one side of the light-emitting cells 314 and a first electron emission source 341 formed on an inner side surface of the first electrode 331. The second electron emission member includes a second electrode 332 formed on the other side of the light-emitting cells 314 and a second electron emission source 342 formed on an inner side surface of the second electrode 332. The first and second electron emission sources 341 and 342 are formed of BNBS having an excellent electron emission characteristic.

If a predetermined voltage is applied to the first electrode 331, the first electron emission source 341 emits a first electron beam (E₁-beam) into the light-emitting cells 314. If a predetermined voltage is applied to the second electrode 332, the second electron emission source 342 emits a second electron beam (E₂-beam) into the light-emitting cells 314. The first and second electron beams (E₁-beam, E₂-beam) are alternately emitted into the light-emitting cells 314. The first and second electron beams excite the excitation gas. The excited excitation gas is stabilized and UV rays for exciting the light-emitting layers 315 are generated. Thus, the E₁-beam and the E₂-beam may have an energy which is larger than an energy needed to excite the excitation gas and is smaller than an energy needed to ionize the excitation gas. Specifically, when the excitation gas including Xe is used, the first and second beams may have an energy of from about 8.28 to about 12.13 eV needed to excite Xe.

In the display device having the above structure, voltages of types illustrated in FIG. 12 can be applied to respective electrodes. A detailed description thereof has been made as above and thus will be omitted.

In the display device according to the present embodiment, each electron emission member includes a first electrode 431 or a second electrode 432 and electron emission sources 441 and 442 formed on the first and second electrodes 431 and 432, respectively. However, each electron emission member may include a cathode electrode 131′, an electron emission source 140′ formed on the cathode electrode 131′, and a grid electrode 133 disposed to be adjacent to the electron emission source 140′ (See FIG. 8).

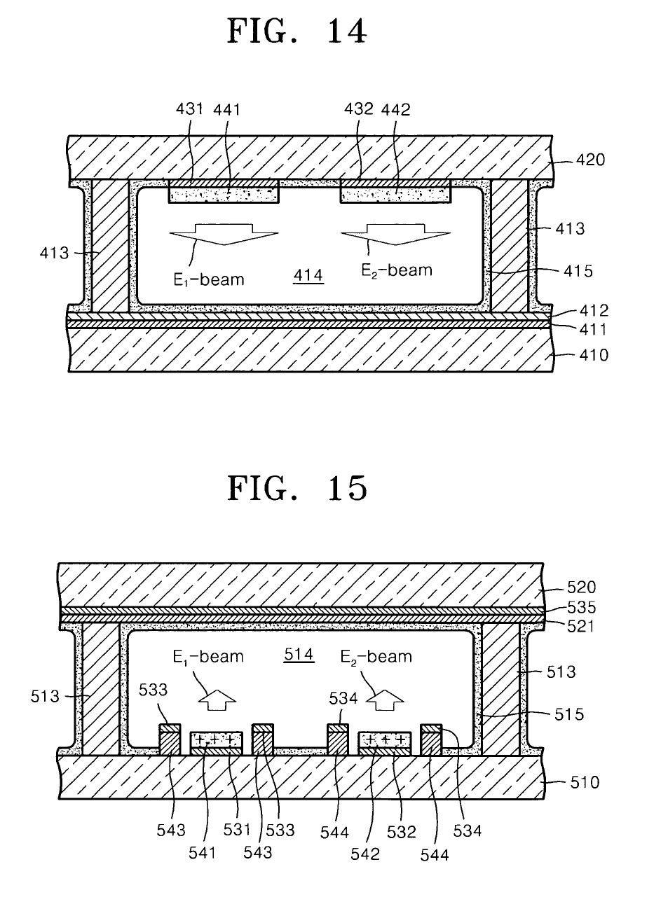

FIG. 14 is a schematic cross-sectional view of a portion of a display device according to another embodiment.

Referring to FIG. 14, a first substrate 410 which is a lower substrate and a second substrate 420 which is an upper substrate oppose each other at regular intervals. A plurality of barrier ribs 413 which partition a space between the first substrate 410 and the second substrate 420 and form a plurality of light-emitting cells 414 are disposed between the first substrate 410 and the second substrate 420. Light-emitting layers 415 are applied to inner walls of the light-emitting cells 414, and an excitation gas including Xe is filled in the light-emitting cells 414.

A plurality of address electrodes 411 are formed on a top surface of the first substrate 410. The address electrodes 411 are buried by a dielectric layer 412. First and second electron emission members are disposed on a bottom surface of the second substrate 420 in each of the light-emitting cells 414. The first and second electron emission members are disposed in a direction that intersects the address electrodes 411. The first electron emission member includes a first electrode 431 formed on a bottom surface of the second substrate 420 and a first electron emission source 441 formed on a bottom surface of the first electrode 431. The second electron emission member includes a second electrode 432 formed on a bottom surface of the second substrate 420 and a second electron emission source 442 formed on a bottom surface of the second electrode 432. The first and second electron emission sources 441 and 442 are formed of BNBS having excellent electron emission characteristics, as described above.

If a predetermined voltage is applied to the first electrode 431, the first electron emission source 441 emits a first electron beam (E₁-beam) into the light-emitting cells 414. If a predetermined voltage is applied to the second electrode 432, the second electron emission source 442 emits a second electron beam (E₂-beam) into the light-emitting cells 414. The first and second electron beams (E₁-beam, E₂-beam) are alternately emitted into the light-emitting cells 414. Each of the first and second electron beams excites the excitation gas. The excited excitation gas is stabilized and UV rays for exciting the light-emitting layers 415 are generated. Thus, the E₁-beam and the E₂-beam may have an energy which is larger than an energy needed to excite the excitation gas and is smaller than an energy needed to ionize the excitation gas. Specifically, when the excitation gas including Xe is used, the first and second beams may have an energy of from about 8.28 to about 12.13 eV needed to excite Xe.

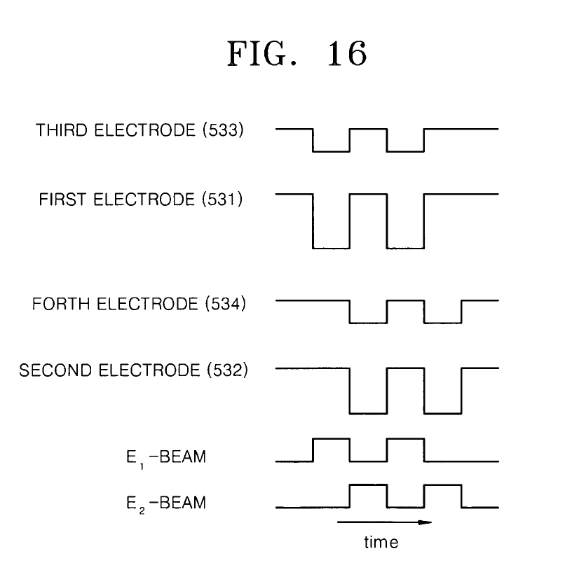

The first and second electrodes 431 and 432 can be formed of a transparent conductive material, such as ITO, so that visible rays can transmit the first, second, third, and fourth electrodes 431, 432, 433, and 434. In the display device having the above structure, voltages of types illustrated in FIG. 12 can be applied to respective electrodes. A detailed description thereof has been made as above and thus will be omitted. As described above, the first substrate 410 becomes a lower substrate and the second substrate 420 becomes an upper substrate. However, according to the current embodiment, the first substrate 410 may be the upper substrate and the second substrate 420 may be the lower substrate. FIG. 15 is a schematic cross-sectional view of a portion of a display device according to another embodiment.

Referring to FIG. 15, a plurality of light-emitting cells 514 partitioned by a plurality of barrier ribs 513 are formed between a first substrate 510 and a second substrate 520. Light-emitting layers 515 are formed on inner walls of the light-emitting cells 514, and an excitation gas for generating UV rays by excitation is filled in the light-emitting cells 514.

First and second electron emission members are disposed on the first substrate 510 in each of the light-emitting cells 514. The first and second electron emission members are disposed on the same surface. The first electron emission member includes a first electrode 531 disposed on a surface of the first substrate 510, a first electron emission source 541 disposed to face the first electrode 531, and a third electrode 533 disposed to be adjacent to the first electron emission source 541. Similarly, the second electron emission member includes a second electrode 532 formed on a surface of the first substrate 510, a second electron emission source 542 disposed to face the second electrode 532, and a fourth electrode 534 disposed to be adjacent to the second electron emission source 542. The first and second electrodes 531 and 532 serve as a cathode electrode and the third and fourth electrodes 533 and 534 serve as a grid electrode. The third and fourth electrodes 533 and 534 are located in a predetermined height from the first substrate 510 by dielectric support layers 543 and 544 to be adjacent to electron emission surfaces of the corresponding electron emission sources 541 and 542. A fifth electrode 535 is disposed on the second substrate 520 that faces the first and second electron emission members. The fifth electrode 535 extends in a direction that intersects the first and second electrodes 531 and 532. The fifth electrode 535 is covered by a dielectric layer.

A method of driving a display device according to an embodiment will now be described. FIG. 16 illustrates voltage types applied to first through fourth electrodes 531, 532, 533, and 534, respectively. Referring to FIG. 16, pulse voltages are applied to the first through fourth electrodes 531, 532, 533, and 534, respectively. In this case, if voltages applied to the first through fourth electrodes 531, 532, 533, and 534, respectively, are V₁, V₂, V₃, and V₄, predetermined voltages are applied to the first, second, third, and fourth electrodes 531, 532, 533, and 534 so that V₁<V₃ and V₂<V₄ can be satisfied. If electron emission pulse voltages are applied to the first electrode 531 and the third electrode 533, a first electron beam (E₁-beam) is emitted, and if another electron emission pulse voltages are applied to the second electrode 532 and the fourth electrode 534, a second electron beam (E₂-beam) is emitted into the light-emitting cells 514. If alternating current (AC) pulse voltages are applied to the first electrode 531 and the second electrode 532, respectively, the first and second electron beams (E₁-beam, E₂-beam) are alternately emitted into the light-emitting cells 514 according to time when pulses voltages are applied to the first electrode 531 and the second electrode 532, respectively. Since the first and second electron emission members are disposed on the same surface to face the same direction, the first and second electron beams (E₁-beam, E₂-beam) are emitted substantially toward the same direction. Although not shown, if a voltage applied to the fifth electrode 535 is V₅ and voltages are applied to the third, fourth, and fifth electrodes 533, 534, and 535 so that V₃, V₄·V₅ can be satisfied, the first electron beam (E₁-beam) and the second electron beam (E₂-beam) emitted into the light-emitting cells 514 may be accelerated toward a progressing direction due to an electrostatic force of the fifth electrode 535. In this regard, the fifth electrode 535 may serve as an anode electrode, and for example, a ground voltage may be applied to the fifth electrode 535.

The display devices illustrated in the above-described embodiments can also be used in a flat lamp that is usually used for a backlight of a liquid crystal display (LCD) as well as an image forming apparatus.

As described above, in the display device according to the present embodiments, the electron emission member including the electron emission source emits an electron beam having an energy needed to only the excitation gas such that the display device is driven at a lower voltage than in the conventional PDP. In addition, since the electron emission source is formed of BNBS having a very excellent electron emission characteristic, a driving voltage can be further reduced and power consumption can be reduced. Since the BNBS has a very solid structure to withstand a shock caused by ions, the life span of the display device can be increased.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A display device comprising:
a first substrate and a second substrate opposing each other at regular intervals;
a plurality of barrier ribs disposed between the first substrate and the second substrate configured to partition a space between the first substrate and the second substrate and form a plurality of light-emitting cells;
an excitation gas filled in the light-emitting cells;
a light-emitting layer formed on at least one inner wall of the light-emitting cells; and
a first electron emission member disposed in each of the light-emitting cells inside the first substrate, configured to emit a first electron beam for exciting the excitation gas into the light-emitting cells and comprising a first electrode formed on an inner surface of the first substrate and a first electron emission source formed of boron nitride bamboo shoot (BNBS) on the first electrode.

2. The display device of claim 1, wherein the first electron beam has an energy which is larger than an energy needed to excite the excitation gas and is smaller than an energy needed to ionize the excitation gas.

3. The display device of claim 1, further comprising a second electrode formed on an inner surface of the second substrate in each of the light-emitting cells.

4. The display device of claim 3, further comprising a third electrode disposed to be adjacent to a surface directed to light-emitting cells of the first electron emission source, wherein, voltages applied to the first electrode, the second electrode and the third electrode, respectively, are V₁, V₂, and V₃, wherein V₁<V₃<V₂ or V₁<V₂=V₃ is satisfied.

5. The display device of claim 3, wherein the second electrode has a mesh structure.

6. The display device of claim 3, further comprising a dielectric layer formed on the inner surface of the second substrate configured to cover the second electrode and wherein a protective layer is formed on the dielectric layer.

7. The display device of claim 1, wherein the excitation gas comprises xenon (Xe) and the first electron beam has an energy of from about 8.28 to about 12.13 eV.

8. The display device of claim 1, further comprising a second electron emission member disposed in each of the light-emitting cells inside the second substrate, emitting a second electron beam for exciting the excitation gas into the light-emitting cells and including a second electrode formed on an inner surface of the second substrate and a second electron emission source formed of BNBS on the second electrode.

9. The display device of claim 8, wherein the second electron beam has an energy which is larger than an energy needed to excite the excitation gas and smaller than an energy needed to ionize the excitation gas.

10. The display device of claim 8, further comprising:
a third electrode disposed to be adjacent to the surface of the light-emitting cells of the first electron emission source; and
a fourth electrode disposed to be adjacent to the surface of the light-emitting cells of the second electron emission source.

11. The display device of claim 10, wherein, voltages applied to the first electrode, the second electrode, the third electrode and the fourth electrode, respectively, are V₁, V₂, V₃, and wherein V₄, V₁<V₃ and wherein V₂<V₄.

12. A display device comprising:
a first substrate and a second substrate opposing each other at regular intervals and forming a plurality of light-emitting cells therebetween;
an excitation gas filled in the light-emitting cells;
a light-emitting layer formed on inner walls of the light-emitting cells; and
first and second electron emission members disposed between the first substrate and the second substrate in each of the light-emitting cells and emitting first and second electron beams for exciting the excitation gas into the light-emitting cells,
wherein the first electron emission member comprises a first electrode disposed on one side of the light-emitting cells and a first electron emission source formed of boron nitride bamboo shoot (BNBS) inside the first electrode, and
the second electron emission member comprises a second electrode
disposed on the other side of the light-emitting cells and a second electron emission source formed of BNBS inside the second electrode.

13. The display device of claim 12, wherein the first and second electron beams have an energy which is larger than an energy needed to excite the excitation gas and smaller than an energy needed to ionize the excitation gas.

14. The display device of claim 12, further comprising:
a third electrode disposed to be adjacent to the surface of the light-emitting cells of the first electron emission source; and
a fourth electrode disposed to be adjacent to the surface of the light-emitting cells of the second electron emission source.

15. The display device of claim 14, wherein, voltages applied to the first electrode, the second electrode, the third electrode and the fourth electrode, respectively, are V₁, V₂, V₃, and V₄, and wherein V₁<V₃ and wherein V₂<V₄.

16. The display device of claim 12, wherein the excitation gas comprises xenon (Xe) and the first and second electron beams independently have an energy of from about 8.28 to about 12.13 eV.

17. The display device of claim 12, further comprising an address electrode formed on an inner surface of the first substrate in each of the light-emitting cells.

18. The display device of claim 17, wherein a dielectric layer is formed on the inner surface of the first substrate configured to cover the address electrode.

19. The display device of claim 12, wherein the first and second electron emission members are formed on facing surfaces of the light-emitting cells.

20. The display device of claim 19, wherein barrier ribs for partitioning the light-emitting cells are disposed between the first substrate and the second substrate, and the first and second electron emission members are formed on side surfaces of facing barrier ribs, respectively.

21. A display device comprising:
a first substrate and a second substrate opposing each other at regular intervals;
a plurality of barrier ribs disposed between the first substrate and the second substrate configured to partition a space between the first substrate and the second substrate and form a plurality of light-emitting cells;
an excitation gas filled in the light-emitting cells;
a light-emitting layer formed on inner walls of the light-emitting cells; and
first and second electron emission members disposed inside the second substrate in each of the light-emitting cells configured to emit first and second electron beams for exciting the excitation gas into the light-emitting cells,
wherein the first electron emission member comprises a first electrode disposed on one portion of an inner surface of the second substrate and a first electron emission source formed of boron nitride bamboo shoot (BNBS) inside the first electrode, and
wherein the second electron emission member comprises a second electrode
disposed on the inner surface of the second substrate and a second electron emission source formed of BNBS inside the second electrode.

22. The display device of claim 21, wherein the first and second electron beams have an energy which is larger than an energy needed to excite the excitation gas and smaller than an energy needed to ionize the excitation gas.

23. The display device of claim 21, further comprising:
a third electrode disposed to be adjacent to the surface of the light-emitting cells of the first electron emission source; and
a fourth electrode disposed to be adjacent to the surface of the light-emitting cells of the second electron emission source.

24. The display device of claim 23, wherein, voltages applied to the first electrode, the second electrode, the third electrode and the fourth electrode, respectively, are V₁, V₂, V₃, and V₄, and wherein V₁<V₃ and V₂<V₄.

25. The display device of claim 21, wherein the excitation gas comprises xenon (Xe) and the first and second electron beams independently have an energy of from about 8.28 to about 12.13 eV.

26. The display device of claim 21, further comprising an address electrode formed on an inner surface of the first substrate in each of the light-emitting cells.

27. The display device of claim 26, wherein a dielectric layer is formed on the inner surface of the first substrate configured to cover the address electrode.
